(19) United States
(12) Patent Application Publication
(10) Pub. No.: US 2006/0082299 A1
(43) Pub. Date: Apr. 20, 2006

(54) Display and method for fabricating the same

(75) Inventor: Nam-Choul Yang, Suwon-si (KR)

Correspondence Address: MCGUIREWOODS, LLP, 1750 TYSONS BLVD, SUITE 1800, MCLEAN, VA, 22102, US

(73) Assignee: Samsung SDI Co., Ltd.

(21) Appl. No.: 11/251,783

(22) Filed: Oct. 18, 2005

(30) Foreign Application Priority Data
Oct. 19, 2004 (KR) 10-2004-0083756

(51) Int. Cl. H05B 33/04

(52) U.S. Cl. 313/512

(57) ABSTRACT

The present invention relates to a display device and a method for fabricating the same. The present invention provides a display comprising a display part formed on a substrate, a sealing member for sealing the display part, a hydrophobic insulation film to cover the substrate and the sealing member, and an adhesion reinforcement layer interposed between the substrate and the hydrophobic insulation film and between the sealing member and the hydrophobic insulation film.

### CROSS REFERENCE TO RELATED APPLICATION

This application claims priority to and the benefit of Korean Patent Application No. 10-2004-0083756, filed on Oct. 19, 2004, the disclosure of which is hereby incorporated by reference for all purposes as if fully set forth herein in its entirety.

### BACKGROUND OF THE INVENTION

1. Field of the Invention

The present invention relates to an organic electroluminescent display comprising double passivation layers formed on an outer part of the display, and a method for fabricating the same.

2. Description of the Background

An organic electroluminescent display is emerging as a next generation flat panel display because it has a high response time of 1 ms or less, it consumes less electricity than other devices, and does not have viewing angle problems due to its self-light emitting characteristics. Furthermore, the organic electroluminescent display may be fabricated at low temperatures and its manufacture is based on existing semiconductor process technology.

An organic electroluminescent display comprises an organic light emitting device formed on an insulation substrate and a sealing substrate formed on an upper part of the organic light emitting device opposite the lower insulation substrate.

However, the organic light emitting device may degrade during operation of the display because a light emitting material and a cathode electrode material in the device have low moisture resistance. The degradation may produce a non-light emitting region called a dark spot. With the passage of time, a dark spot may diffuse to the circumference of the device preventing the device from emitting light.

Double sealing layers that seal an organic electroluminescent device are disclosed in Japanese Publication Laid-Open Publication No. Hei 5-182759 and Japanese Publication Laid-Open Publication No. Hei 7-282975 to solve these degradation problems. These references describe a method for forming a silicon oxide film and a silicon nitride film as a first sealing layer by a sputtering or deposition method and forming a photo-curable resin layer or thermoplastic polymer layer that has moisture resistance as a second sealing layer. However, stability or durability of the sealing layers may deteriorate since they are formed on an upper part of the organic light emitting device.

### SUMMARY OF THE INVENTION

The present invention provides a display that is protected against external moisture and gas by forming a hydrophobic insulation film on an outer part of the display, and a method for fabricating the display.

The present invention also provides a display with an improved sealing function by using an adhesion reinforcement layer to reinforce the adhesive force of a hydrophobic insulation film, and a method for fabricating the display.

Additional features of the invention will be set forth in the description which follows, and in part will be apparent from the description, or may be learned by practice of the invention.

The present invention discloses a display comprising a display part formed on a substrate and a sealing member for sealing the display part, and a hydrophobic insulation film that covers the substrate and the sealing member. The display further comprises an adhesion reinforcement layer that is interposed between the substrate and the hydrophobic insulation film and between the sealing member and the hydrophobic insulation film.

The present invention also discloses a method for fabricating a display comprising the steps of forming a display part on a substrate, sealing the display part with a sealing member, forming an adhesion reinforcement layer to cover the substrate and the sealing member, and forming a hydrophobic insulation film on the adhesion reinforcement layer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a plan view of an organic electroluminescent display of the present invention.

FIG. 2 is a cross sectional view of an organic electroluminescent display taken along line I-I′ of FIG. 1.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

It will be understood that when an element such as a layer, film, region or substrate is referred to as being “on” another element, it can be directly on the other element or intervening elements may also be present. In contrast, when an element is referred to as being “directly on” another element, there are no intervening elements present.

A display of the present invention improves adhesive contact between a substrate and a sealing member by including a hydrophobic parylene passivation layer that prevents penetration of external moisture and gas and an adhesion reinforcement layer formed of a silane or a silazane that functions as a substrate surface modification layer and supplements the adhesive force of the parylene passivation layer.

Furthermore, a display of the present invention may have a passivation layer of uniform thickness by forming an adhesion reinforcement layer formed of a silane or a silazane and a parylene passivation layer by a vapor deposition method.

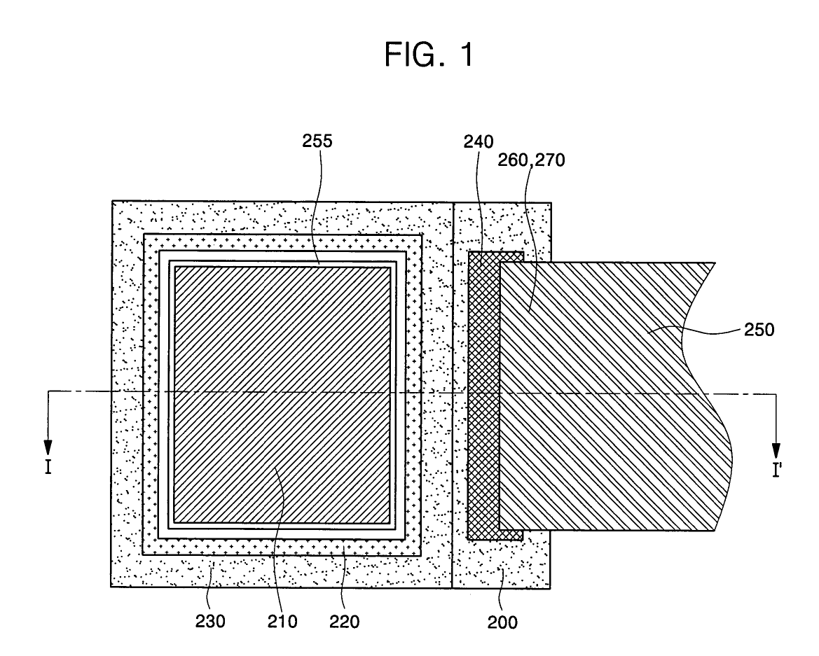

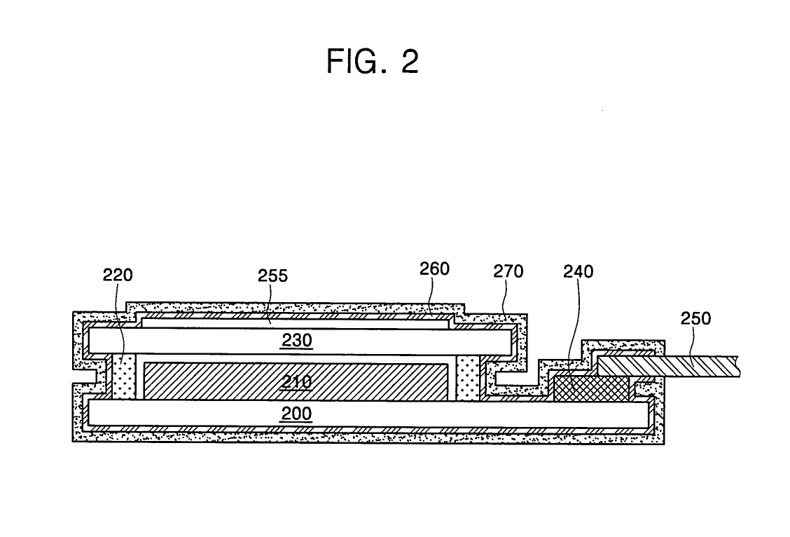

FIG. 1 is a plan view of an organic electroluminescent display of the present invention, and FIG. 2 is a cross sectional view of an organic electroluminescent display taken along a line I-I′ of FIG. 1.

As shown in FIG. 1 and FIG. 2, a display device of the present invention includes a display part 210 and a contour part. The display part 210 includes a pixel part and a pad part 240 that are formed on a substrate 200. The pixel part comprises an active region formed of unit pixels, a thin film transistor, and a capacitor. The contour part includes wiring that is coupled with the active region.

The display part may include an organic electroluminescent display or a liquid crystal display.

For example, if the display part 210 includes an organic electroluminescent device, the organic electroluminescent device is formed on a substrate and comprises a first electrode, a second electrode, and an organic layer comprising a light emitting layer interposed between the electrodes. If the first electrode is an anode, the second electrode is a cathode electrode. If the first electrode is a cathode, the second electrode is an anode.

Furthermore, the organic layer is formed in multiple layers including at least one or more of a hole injection layer (HIL), a hole transport layer (HTL), a light emitting layer, a hole blocking layer (HBL), an electron transport layer (ETL) and an electron injection layer (EIL). Furthermore, the thin film transistor and the capacitor are formed such that they are coupled with each organic electroluminescent device per unit pixel and are coupled with wirings such as gate lines and data lines.

The pad part 240 couples the display part 210 and the external circuit module. The pad part 240 and the external circuit module are coupled through a connector 250. The connector 250 may include, but is not limited to Flexible Printed Circuit (FPC), Chip on Flex (COF) and Chip on Glass (COG).

The display part 210 may be sealed by a sealing member. For example, the sealing member may include a sealant 220 formed on all sides of the display part 210 and a sealing substrate 230 formed on an upper part of the display part 210 to seal the display part 210.

An adhesion reinforcement layer 260 may be formed to cover the substrate 200 and the sealing members 220, 230.

The adhesion reinforcement layer 260 modifies the surface of the substrate and may be formed of a silane or a silazane, for example.

The adhesion reinforcement layer may cover about 30% to about 100% of the surface of the substrate. Therefore, the adhesion reinforcement layer may include a continuously formed film and a discontinuously formed film.

The silane may be represented by the following Chemical Structure 1: 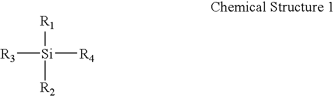
where R₁ is selected from the group consisting of a hydroxyl group, a halogen group, a linear alkoxy group having 1 to 6 carbon atoms and a branched alkoxy group having 1 to 6 carbon atoms. R₂ and R₃ may each be selected from the group consisting of a hydroxyl group, a halogen group, a linear alkoxy group having 1 to 6 carbon atoms, a branched alkoxy group having 1 to 6 carbon atoms, a linear alkyl group having 1 to 22 carbon atoms, a branched alkyl group having 1 to 22 carbon atoms, a cyclic alkyl group having 3 to 7 carbon atoms, a phenyl group, a naphthyl group and a chlorophenyl group. R₄ may be selected from the group consisting of a linear alkyl group having 1 to 22 carbon atoms, a branched alkyl group having 1 to 22 carbon atoms, a cyclic alkyl group having 3 to 7 carbon atoms, a phenyl group, a naphthyl group and a chlorophenyl group.

The silazane may be represented by the following Chemical Structure 2: 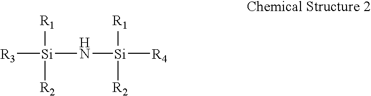
where R₁ and R₂ are each selected from the group consisting of an alkyl group having 1 to 18 carbon atoms, a phenyl group, and a vinyl group. R₃ may be selected from the group consisting of an alkyl group having 1 to 18 carbon atoms, a cyclic alkyl group having 2 or 3 carbon atoms, a phenyl group, and a vinyl group.

The adhesion reinforcement layer 260 may be formed by vapor deposition. Furthermore, the vapor deposited adhesion reinforcement layer 260 may be cured at a temperature of 150° C. or less to improve the bond between a substrate of the film and the sealing member. The adhesive property of the adhesion reinforcement layer 260 is enhanced by forming the adhesion reinforcement layer 260 at the above-mentioned curing temperature.

A hydrophobic insulation film 270 may be formed on the adhesion reinforcement layer 260. The hydrophobic insulation film 270 may include a parylene film.

The parylene film may be represented by the following Chemical Structure 3: 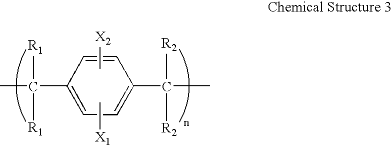
where R₁ and R₂, which are independent from each other, are hydrogen or a halogen, and X₁ and X₂, which are not related to each other, are one selected from the group consisting of hydrogen, halogen, trifluromethyl (CF₃), amine group (NH₂) and aminomethyl (CH₂NH₃).

The parylene film 270 may be formed by a vapor deposition method. The parylene film may be formed on a substrate at a chamber temperature of about 10° C. to about 120° C. by the vapor deposition method to improve the physical properties of the parylene film.

Furthermore, the vapor deposition method is superior to a dipping method because it is safer, uniformity of a film formed on the substrate is improved to maintain constant thickness of the film at any part of the substrate irrespective of its shape, thickness of the film is easily controlled, and transparency of the film is maintained.

Characteristics of a display are further improved by forming the adhesion reinforcement layer and the hydrophobic insulation film by vapor deposition because this method prevents light distortion caused by the adhesion reinforcement layer and the hydrophobic insulation film.

An Si—O—Si bond is formed between the substrate and the sealing member and a surface modification layer formed of a silane or a silazane. The adhesive force in the interface of the surface modified substrate that includes silane or silazane 260 and the parylene film 270 improves because they have similar polarities, and thus, similar hydrophobic properties.

Specifically, the surface modification layer formed of a silane or a silazane (the adhesion reinforcement layer 260) may modify surfaces of the substrate and the sealing member by Si—O—Si bonding and a functional group that is not bonded with the substrate or the sealing member. Accordingly, the surface modification layer reinforces the adhesive force of a parylene hydrophobic insulation film 270 that has a weak adhesive force with the substrate.

Thus, a parylene film that has strong hydrophobic properties prevents penetration of external moisture or gas, and the surface modification layer formed of a silane or a silazane improves the adhesive force with the substrate 200 or the sealing substrate 230.

The hydrophobic insulation film 270 may additionally cover parts of the pad part 240 and the connector 250.

A functional film 255 may be included to improve the contrast ratio of a display or a polarizer, for example. If a functional film 255 is formed on a side of the sealing substrate 230 or the substrate 220 as shown in FIG. 2, the adhesion reinforcement layer 260 may be formed on the functional film 255. The adhesion reinforcement layer 260 may be formed to cover parts or all of the functional film 255, the pad part 240, and the connector 250.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display, comprising:
a display part formed on a substrate;
a sealing member that seals the display part;
a hydrophobic insulation film that covers the substrate and the sealing member; and
an adhesion reinforcement layer interposed between the substrate and the hydrophobic insulation film, and between the sealing member and the hydrophobic insulation film.

2. The display of claim 1,
wherein the adhesion reinforcement layer modifies a surface of the substrate.

3. The display of claim 1,
wherein the adhesion reinforcement layer covers about 30% to about 100% of the surface of the substrate.

4. The display of claim 1,
wherein the adhesion reinforcement layer comprises a silane or a silazane.

5. The display of claim 4,
wherein the silane is represented by the following chemical structure 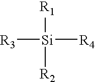
wherein R₁ is selected from the group consisting of a hydroxyl group, a halogen group, a linear alkoxy group having 1 to 6 carbon atoms, and a branched alkoxy group having 1 to 6 carbon atoms,
wherein R₂ and R₃ are each selected from the group consisting of a hydroxyl group, a halogen group, a linear alkoxy group having 1 to 6 carbon atoms, a branched alkoxy group having 1 to 6 carbon atoms, a linear alkyl group having 1 to 22 carbon atoms, a branched alkyl group having 1 to 22 carbon atoms, a cyclic alkyl group having 3 to 7 carbon atoms, a phenyl group, a naphthyl group, and a chlorophenyl group, and
wherein R₄ is selected from the group consisting of a linear alkyl group having 1 to 22 carbon atoms, a branched alkyl group having 1 to 22 carbon atoms, a cyclic alkyl group having 3 to 7 carbon atoms, a phenyl group, a naphthyl group and a chlorophenyl group.

6. The display of claim 4,
wherein the silazane is represented by the following chemical structure 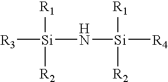
wherein R₁ and R₂ are each selected from the group consisting of an alkyl group having hydrogen or 1 to 18 carbon atoms, a phenyl group, and a vinyl group, and
wherein R₃ is one selected from the group consisting of an alkyl group having hydrogen or 1 to 18 carbon atoms, a cyclic alkyl group having 2 or 3 carbon atoms, a phenyl group, and a vinyl group.

7. The display of claim 1,
wherein the hydrophobic insulation film is a parylene film.

8. The display of claim 7,
wherein the parylene film is represented by the following chemical structure 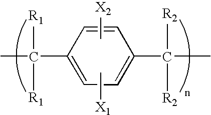
wherein R₁ and R₂ are each hydrogen or a halogen,
wherein and X₁ and X₂ are each selected from the group consisting of hydrogen, halogen, trifluromethyl (CF₃), amine group (NH₂) and aminomethyl (CH₂NH₃).

9. The display of claim 1, further comprising:
a pad part for coupling the display part and an external circuit module and
a connector for coupling the pad part and the external circuit module.

10. The display of claim 8,
wherein the hydrophobic insulation film covers at least parts of the pad part and the connector.

11. The display of claim 1,
wherein the display part comprises an organic electroluminescent display or a liquid crystal display.

12. A method for fabricating a display, comprising:
forming a display part on a substrate;
sealing the display part with a sealing member;
forming an adhesion reinforcement layer to cover the substrate and the sealing member; and
forming a hydrophobic insulation film on the adhesion reinforcement layer.

13. The method of claim 12,
wherein the adhesion reinforcement layer comprises a material that modifies a surface of the substrate.

14. The method of claim 13,
wherein the adhesion reinforcement layer covers about 30% to about 100% of the surface of the substrate.

15. The method of claim 13,
wherein the adhesion reinforcement layer comprises a silane or a silazane.

16. The method of claim 15,
wherein the adhesion reinforcement layer is formed by vapor deposition.

17. The method of claim 15,
wherein the adhesion reinforcement layer cured at a temperature of 150° C. or less.

18. The method of claim 12,
wherein the hydrophobic insulation film comprises parylene.

19. The method of claim 18,
wherein the parylene film is formed by vapor deposition.

20. The method of claim 19,
wherein the parylene film is formed on a substrate at a temperature of about 10° C. to about 120° C.
